(19) United States
(12) Patent Application Publication
(10) Pub. No.: US 2008/0055052 A1
(43) Pub. Date: Mar. 6, 2008

(54) Network transmission system and power line communication device thereof

(75) Inventors: Jen-Ho Chang, Taoyuan Hsien (TW); Ming-Fa Wu, Taoyuan Hsien (TW); Han-Cheng Hsu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/882,861

(22) Filed: Aug. 6, 2007

(30) Foreign Application Priority Data
Aug. 30, 2006 (TW) 095131981

(51) Int. Cl. H04M 11/04

(52) U.S. Cl. 340/310.11

(57) ABSTRACT

A power line communication (PLC) device, which is electrically connected with a power line, a power transforming device and an electronic device, includes a transmission element, a power transmitting element and a data transmission element. The transmission element is electrically connected with the power line for receiving a power source and communicating a data through the power line. The power transmitting element, which is electrically connected with the transmission element and the power transforming device, transmits the power source to the power transforming device, so that the power transforming device generates a work power to the electronic device. The data transmission element is electrically connected with the transmission element and the electronic device for transmitting the data to the electronic device.

### CROSS REFERENCE TO RELATED APPLICATIONS

This Non-provisional application claims priority under 35 U.S.C. §119(a) on Patent Application No(s). 095131981, filed in Taiwan, Republic of China on Aug. 30, 2006, the entire contents of which are hereby incorporated by reference.

### BACKGROUND OF THE INVENTION

1. Field of Invention

The present invention relates to a transmission system and a communication device thereof. In particular, the present invention relates to a network transmission system and a power line communication (PLC) device thereof, which can reduce the space to wires, eliminate the interference between the devices, and transmit power source and data simultaneously or separately.

2. Related Art

Due to the progressive of information science, the desired information can be easily retrieved by network. Accordingly, the demands on the data transceiving speed are very critical. For example, terminal devices, such as computers, household appliances and consumer electronics, are connected with communication apparatus by network lines. Then, a network transmission system is set up. When the number of the terminal devices increases, more network lines are needed. These increased network lines are very displeasing and the connection of the network lines is very complex and difficult. Furthermore, the cost of the network lines also increases.

To solve this problem, a conventional power line communication (PLC) device uses the existing power lines for data transmission in the network. The PLC device uses a power socket as the transmission connector of the network, so that it is not necessary to use network lines in this network. On the other hand, the existing power lines are employed to transmit network data and connect with the PLC device and electronic apparatuses in this network transmission system.

As shown in FIG. 1, a conventional network transmission system 1 is electrically connected with a power line P, and includes a PLC device 11, an electronic device 12 and a transformer 13. The voltage specifications of the transformer 13 depend on the electronic device 12. The PLC device 11 and the transformer 13 are both electrically connected with the power line P and the electronic device 12. The PLC device 11 can transmit data D1 to the electronic device 12 through a power plug (not shown) and the power line P. In addition, the transformer 13 can receive a power source S1 through the power plug (not shown) and the power line P. Then, the transformer 13 transforms the power source S1 into a work power S2 and transmits the work power S2 to the electronic device 12. When several electronic devices 12 are installed in the network, two or more power plugs must be used, so that two or more power sockets are correspondingly required. In addition, the PLC device 11 must electrically connected with a plurality of transformers 13 and electronic devices 12, all of which result in complication and difficulty of the connection. Therefore, the conventional system is inconvenient, and the complex connection will occupy many power sockets and have increasing cost.

### SUMMARY OF THE INVENTION

In view of the foregoing, the present invention is to provide a network transmission system and a PLC device thereof that can be easily set up and conveniently cooperate with any electronic device for transmitting power source and data.

To achieve the above, the present invention provides a power line communication (PLC) device, which is electrically connected with a power line, a power transforming device and an electronic device. The PLC device includes a transmission element, a power transmitting element and a data transmission element. The transmission element is electrically connected with the power line for receiving a power source and communicating a data through the power line. The power transmitting element, which is electrically connected with the transmission element and the power transforming device, transmits the power source to the power transforming device. Then, the power transforming device transforms the power source so as to provide a work power to the electronic device. The data transmission element, which is electrically connected with the transmission element and the electronic device, transmits the data to the electronic device.

To achieve the above, the present invention also provides a network transmission system, which is electrically connected with a power line and an electronic device. The network transmission system includes a power transforming device and a power line communication (PLC) device. The power transforming device is electrically connected with the electronic device. The PLC device is electrically connected with the power transforming device and the electronic device, and includes a transmission element, a power transmitting element and a data transmission element. The transmission element is electrically connected with the power line for receiving a power source and communicating a data through the power line. The power transmitting element, which is electrically connected with the transmission element and the power transforming device, transmits the power source to the power transforming device. Then, the power transforming device transforms the power source so as to provide a work power to the electronic device. The data transmission element, which is electrically connected with the transmission element and the electronic device, transmits the data to the electronic device.

As mentioned above, the PLC device of the present invention uses the transmission element for receiving power source and transmitting data through the power line. The PLC device of the present invention further uses the power transmitting element for transmitting the power source to a power transforming device, which can generate the work power and transmit it to the electronic device. The PLC device further includes the data transmission element for transmitting the data to the electronic device. Compared with the prior art, the present invention integrates the transmissions of power source and data in a single PLC device, so that the PLC device can be electrically connected with the power line and the power transforming device. As using the PLC device of the present invention to set up the network transmission system, the accommodating space for the wires connecting the PLC device and the power lien can be reduced, and the interference between the PLC device and the power transforming device can be eliminated. In addition, the PLC device of the present invention can cooperate with mostly kinds of electronic devices and thus provide sufficient performance and quality.

### BRIEF DESCRIPTION OF THE DRAWINGS

The present invention will become more fully understood from the detailed description given herein below illustration only, and thus is not limitative of the present invention, and wherein:

FIG. 1 is a schematic diagram showing a conventional network transmission system;

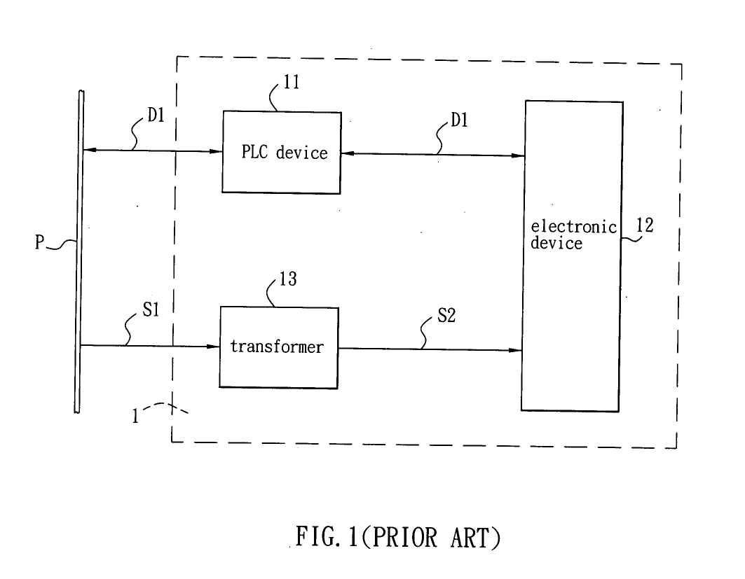

FIG. 2 is a schematic diagram showing a network transmission system according to an embodiment of the present invention;

FIG. 3 is a schematic diagram showing the network transmission system according to the embodiment of the present invention, wherein the PLC device has a power socket and the power transforming device has a power plug; and

FIG. 4 is a schematic diagram showing the network transmission system according to the embodiment of the present invention, wherein the PLC device has a male power connector and the power transforming device has a female power connector.

### DETAILED DESCRIPTION OF THE INVENTION

The present invention will be apparent from the following detailed description, which proceeds with reference to the accompanying drawings, wherein the same references relate to the same elements.

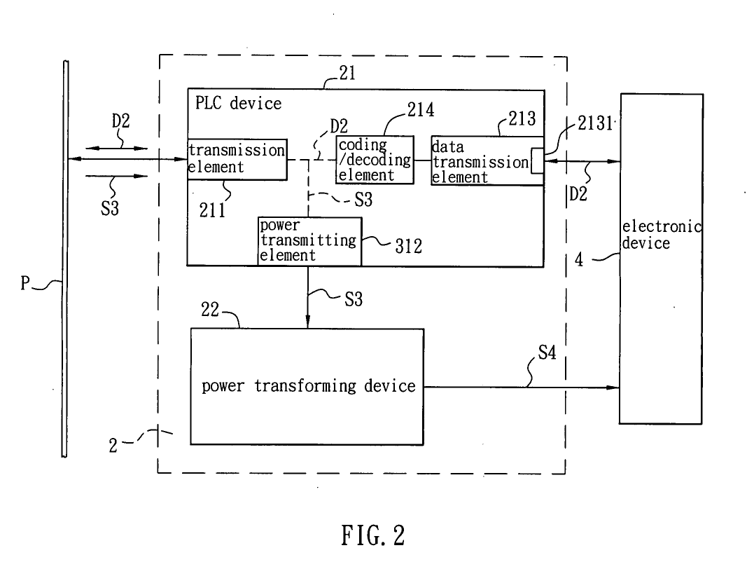

With reference to FIG. 2, a network transmission system 2 according to an embodiment of the present invention is electrically connected with a power line P and an electronic device 4. The network transmission system 2 includes a power line communication (PLC) device 21 and a power transforming device 22.

In the embodiment, the PLC device 21 is electrically connected with the power transforming device 22 and the electronic device 4. The PLC device 21 includes a transmission element 211, a power transmitting element 212 and a data transmission element 213.

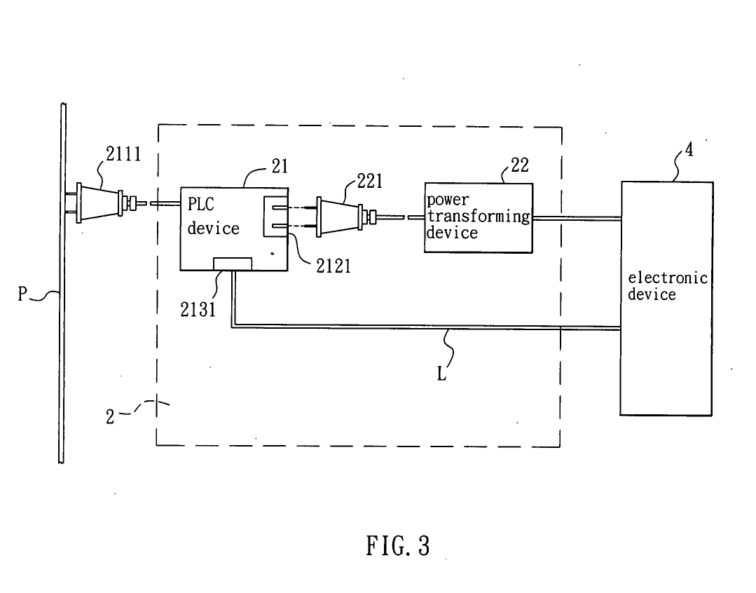

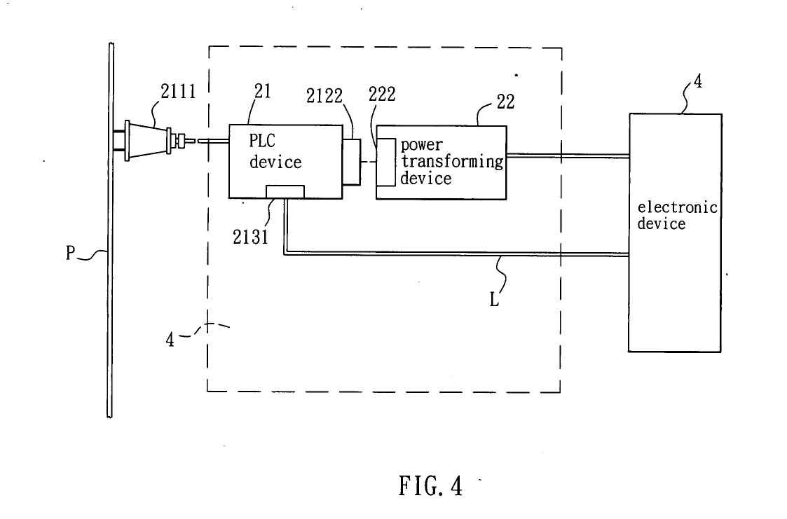

The transmission element 211 is electrically connected with the power line P, the power transmitting element 212 and the data transmission element 213. The transmission element 211 receives a power source S3 from the power line P and transmits a data D2 through the power line P, simultaneously or separately. Then, the transmission element 211 transmits the power source S3 to the power transmitting element 212, and transmits the data D2 to the data transmission element 213. In the embodiment, the transmission element 211 has a power plug 2111 as shown in FIG. 3 or FIG. 4, and the transmission element 211 is electrically connected with the power line P through the power plug 2111.

Referring further to FIG. 2, the power transmitting element 212 of the PLC device 21 is electrically connected with the power transforming device 22. The power transmitting element 212 receives the power source S3 from the transmission element 211 and then transmits the power source S3 to the power transforming device 22. In the embodiment, the power transmitting element 212 has a power socket 2121 (as shown in FIG. 3) or a male power connector 2122 (as shown in FIG. 4) for transmitting the power source S3.

Back to FIG. 2, the PLC device 21 further includes a coding/decoding element 214, which is electrically connected with the transmission element 211 and the data transmission element 213. The coding/decoding element 214 encodes or decodes the data D2, and then transmits the data D2 to the transmission element 211 or the data transmission element 213. In practice, the coding/decoding element 214 can be an encoding element or a decoding element.

As shown in FIGS. 2 to 4, the data transmission element 213 has a network connector 2131 for electrically connected with the electronic device 4. The data transmission element 213 transmits the data D2 to the electronic device 4 through the network connector 2131. In the embodiment, the network connector 2131 is, for example but not limited to, an RJ-45 connector. The data transmission element 213 can transmit the data D2 to the electronic device 4 by, for example but not limited to, a wire transmission or a wireless transmission. In the embodiment, the data transmission element 213 transmits the data D2 to the electronic device 4 by a wire transmission. In this case, the data transmission element 213 transmits the data D2 to the electronic device 4 through a wire L. The wire L is, for example but not limited to, a network wire such as a CAT. 5 wire. The PLC device 21 utilizes the wire L to electrically connect its network connector 2131 to the electronic device 4. Thus, the data D2 can be transmitted from the data transmission element 213 to the electronic device 4 through the network connector 2131 and the wire L. Of course, the data transmission element 213 may transmit the data D2 to the electronic device 4 by a wireless transmission, such as a bluetooth transmission, an IR transmission, a Home RF transmission, a HomeRF multimedia transmission or an IEEE 802.11 transmission.

In practice, the power transforming device 22 is detachably installed in the PLC device 21. As shown in FIG. 3, the power transforming device 22 has a power plug 221, so that the power transforming device 22 can connect to the power transmitting element 212 through the power plug 221 and the power socket 2121. Alternatively, as shown in FIG. 4, the power transforming device 22 has a female power connector 222, so that the power transforming device 22 can electrically connect to the power transmitting element 212 through the female power connector 222 and the male power connector 2122. Accordingly, the power transforming device 22 can receive the power source S3 from the power transmitting element 212, and then transform the power source S3 to a work power S4, which is transmitted to the electronic device 4. In the embodiment, the power transforming device 22 is, for example but not limited to, a transformer. Of course, the power transmitting element 212 may have a power plug while the power transforming device 22 has a power socket, or the power transmitting element 212 may have a female power connector while the power transforming device 22 has a male power connector (not shown).

The electronic device 4 can receive or transmit the data D2 and can further process the data D2. In the embodiment, the electronic device 4 is, for example but not limited to, a switch hub, a router, a setup box or an IP camera.

Please refer to FIG. 2 again. The operations of the network transmission system 2 will be described hereinafter. The transmission element 211 of the PLC device 21 simultaneously or separately receives the data D2 and the power source S3 by the power line P. Then, the transmission element 211 respectively processes the data D2 and the power source S3. The transmission element 211 transmits the power source S3 to the power transforming device 22 through the power transmitting element 212. The power transforming device 22 then transforms the power source S3 to generate the work power S4, which is transmitted to the electronic device 4. In addition, the transmission element 211 transmits the data D2 to the coding/decoding element 214, which encodes or decodes the data D2. Then, the encoded/decoded data D2 is transmitted to the electronic device 4 through the data transmission element 213. Finally, the electronic device 4 can process the data D2. In addition, when the electronic device 4 transmits the data D2 to a receiver of another electronic device (not shown), the data D2 is firstly transmitted from the electronic device 4 to the PLC device 21. In more details, the data transmission element 213 receives the data D2 from the electronic device 4. Then, the data D2 is encoded or decoded by the coding/decoding element 214. The encoded/decoded data D2 is then transmitted to the power line P through the transmission element 211. Finally, the data D2 is transmitted to another electronic device through the power line P.

In the embodiment, the PLC device 21 of the network transmission system 2 can simultaneously or separately receive the power source S3 and transmit the data D2. The power source S3 is then transmitted to the power transforming device 22, which generates the work power to the electronic device 4, and the data D2 is then transmitted to the electronic device 4. As mentioned above, the PLC device 21 can integrate the transmissions of the power source S3 and the data D2. In addition, the PLC device 21 utilizes a single wire to electrically connect with the power line P, so the setup of the network transmission system 2 is easier. Moreover, the accommodating space for the connection between the network transmission system 2 and the power line P is smaller, and the interference between the PLC device 21 and the power transforming device 22 is eliminated. When cooperating with the PLC device 21, the terminal apparatuses are not need to be modified. In addition, the PLC device 21 is practically more standardized. It can cooperate with various kinds of power transforming devices 22, which have different transforming parameters, for different electronic devices 4. Accordingly, the PLC device 21 is unnecessary to be modified for different electronic devices.

In summary, the PLC device of the present invention includes the transmission element for receiving power source and transmitting data through the power line. The PLC device of the present invention further includes the power transmitting element for transmitting the power source to a power transforming device, which can generate the work power and transmit it to the electronic device. The PLC device further includes the data transmission element for transmitting the data to the electronic device. Compared with the prior art, the present invention integrates the transmissions of power source and data in a single PLC device, so that the PLC device can be electrically connected with the power line and the power transforming device. As using the PLC device of the present invention to set up the network transmission system, the accommodating space for the wires connecting the network transmission system and the power line can be reduced, and the interference between the PLC device and the power transforming device can be eliminated. In addition, the PLC device of the present invention can cooperate with mostly kinds of electronic devices and thus provide sufficient performance and quality.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A power line communication (PLC) device, which is electrically connected with a power line, a power transforming device and an electronic device, the PLC device comprising;
a transmission element electrically connected with the power line for receiving a power source and communicating a data through the power line;
a power transmitting element electrically connected with the transmission element and the power transforming device for transmitting the power source to the power transforming device, wherein the power transforming device transforms the power source so as to provide a work power to the electronic device; and
a data transmission element electrically connected with the transmission element and the electronic device for transmitting the data to the electronic device.

2. The PLC device according to claim 1, further comprising an encoding element and/or a decoding element.

3. The PLC device according to claim 1, wherein the data transmission element transmits the data to the electronic device by a wire transmission or a wireless transmission.

4. The PLC device according to claim 3, wherein the wireless transmission is a bluetooth transmission, an IR transmission, a Home RF transmission, a HomeRF multimedia transmission or an IEEE 802.11 transmission.

5. The PLC device according to claim 3, wherein the data transmission element transmits the data to the electronic device through a wire or a network line.

6. The PLC device according to claim 5, wherein the data transmission element has a network connector or an RJ-45 connector for electrically connecting with the network line or the wire.

7. The PLC device according to claim 1, wherein the power transmitting element has a power plug and the power transforming device correspondingly has a power socket, and vice versa.

8. The PLC device according to claim 1, wherein the transmission element has a power plug for electrically connecting with the power line.

9. The PLC device according to claim 1, wherein the electronic device is a modem, a switch hub, a router, a setup box or an IP camera.

10. The PLC device according to claim 1, wherein the power transforming device is a transformer.

11. A network transmission system, which is electrically connected with a power line and an electronic device, the network transmission system comprising;
a power transforming device electrically connected with the electronic device; and
a power line communication (PLC) device electrically connected with the power transforming device and the electronic device, the PLC device comprising:
a transmission element electrically connected with the power line for receiving a power source and communicating a data through the power line;
a power transmitting element electrically connected with the transmission element and the power transforming device for transmitting the power source to the power transforming device, wherein the power transforming device transforms the power source so as to provide a work power to the electronic device; and
a data transmission element electrically connected with the transmission element and the electronic device for transmitting the data to the electronic device.

12. The system according to claim 11, wherein the PLC device further comprises an encoding element and/or a decoding element.

13. The system according to claim 11, wherein the data transmission element transmits the data to the electronic device by a wire transmission or a wireless transmission.

14. The system according to claim 13, wherein the wireless transmission is a bluetooth transmission, an IR transmission, a Home RF transmission, a HomeRF multimedia transmission or an IEEE 802.11 transmission.

15. The system according to claim 13, wherein the data transmission element transmits the data to the electronic device through a wire or a network line.

16. The system according to claim 15, wherein the data transmission element has a network connector or an RJ-45 connector for electrically connecting with the network line or the wire.

17. The system according to claim 11, wherein the power transmitting element has a power plug and the power transforming device correspondingly has a power socket, and vice versa.

18. The system according to claim 11, wherein the transmission element has a power plug for electrically connecting with the power line.

19. The system according to claim 11, wherein the electronic device is a modem, a switch hub, a router, a setup box or an IP camera, and the power transforming device is a transformer.

20. The system according to claim 11, wherein the power transforming device is detachably installed in the PLC device.
